(19) United States
(12) Patent Application Publication
(10) Pub. No.: US 2009/0135676 A1
(43) Pub. Date: May 28, 2009

(54) METHOD AND DEVICE FOR CELESTIAL TIME KEEPING

(76) Inventor: Kevin W. Kelley, Nanaimo (CA)

Correspondence Address: Kevin W. Kelley, P.O. Box 150330, San Rafael, CA, 94915, US

(21) Appl. No.: 12/271,941

(22) Filed: Nov. 17, 2008

Related U.S. Application Data
(60) Provisional application No. 60/988,797, filed on Nov. 18, 2007.

(51) Int. Cl. G04B 49/00

(52) U.S. Cl. 368/15

(57) ABSTRACT

The present invention is a method and device of time-keeping on a location of a celestial body (first celestial body). In this invention, we determine the location of a first celestial body with respect to a second celestial body and the motion of the first celestial body with respect to a second celestial body and other celestial bodies, as it moves along its celestial path in universe. By using the location and motion of the first celestial body to represent a point in time on the first or second celestial body and using the motion of the first celestial body to represent progression of time on the first or second celestial body, as they move in universe along their celestial paths. Where, the first celestial body could be any one of a moon, an asteroid, a planetoid, a planet, a star, a galaxy, a cluster of galaxies and an arbitrary point in the universe.

### CROSS-REFERENCE TO RELATED APPLICATIONS

This application claims the benefit of U.S. Provisional Application No. 60/988,797, filed on Nov. 18, 2007, herein incorporated by reference

### A. BACKGROUND OF THE INVENTION

1. Field of the Invention

The present invention generally relates to a method and device for visualizing, understanding, keeping and telling time. More particularly, the present invention pertains to design and implementation for time keeping based on celestial movements and relationships.

2. Description of the Related Art

The analog clock face and the wall calendar were invented in the 1500's (or even earlier) when the Earth was known to be flat (ret http://en.wikipedia.org/wiki/Clock). Antiquated and out of date as they are, we are still using them as our primary if not our only means of keeping time. Our scientific learning and understanding of time and space have grown exponentially over the last Millennium. We now have a good sense of how far back time and both cosmic and terrestrial evolution go and we can imagine equal distances and durations into the future.

The concept of time is related to motion, or change. Moreover, time is related to how things change (e.g. in location) with respect to each other. The most fundamental units of time have been used as a measure of our relationship to the sun. For example, a typical day is one full revolution of the Earth in relationship to the sun a year one orbit of the Earth about the sun, etc. Thus time keeping devices are analogues of these basic movements.

Our prior art search on Google and various patent databases has revealed a few patents that do use or represent other celestial movements in a graphic way. For example, http://theorderoftime.com/science/galactic.html talks about the “Galactic” time and the value of looking at time and measuring time from a galactic perspective. The advantage of the present invention is that the exact position of the earth—would be what it is and would be the a priori determinant and would give accurate representation. And the time notation of if . . . by whichever time keeping system that would be used to tell the time (i.e. western, Islamic, “galactic system” would vary. The present invention models the actual movements and positions and then we can append to them any time keeping system.

Again US published patent number 20060164920, discloses methods and device for time-keeping by precisely calculating data relating to the center of the Milky Way galaxy. The invention is a method of time-keeping by calculating the direction of the galactic center at a desired time, and displaying an indicator of at least one of the rise time, the rise azimuth and the current elevation angle.

Also there are currently some astronomical planetary programs and visualization (digital for the personal computer or planetariums etc) that are trying to show larger volumetric, temporal, animated models of the universe and time is an element in some of these.

However, in general the prior art does not show the whole picture of our part of the universe as it scales in the whole universe. And they certainly do not appear to have presented the combined flow of these objects in relationship to each other, nor their individual and collective movements and paths through space. Further the prior art does not reveal the paths the objects trace through space and time, nor do they ever use what they do as a method of showing or teaching time much less as a method for creating a way to “see” and proportionally mark time.

Therefore, there is a need to have a modern clock and calendar that reflects these new understandings or that helps us track these time frames and correlated events.

### SUMMARY OF THE INVENTION

An object of the present invention is to have method and device for visualizing, understanding, teaching and keeping time based on dynamic model of the related celestial bodies.

Embodiments of the present invention comprise a method and device for time keeping by determining and visualizing the location of a celestial body with respect to another celestial body. Further, the time on earth is a spot or area on earth in relationship to other celestial bodies. And when we are tracking the paths, back in time, we are looking at where these bodies were, and their paths, back in time and space, For example, if we go back 1000 years . . . no (celestial) body is there—we are just looking at an imaginary “Place” in space-time that things (these celestial bodies and or spots on them) in theory were back then. The location can be determined by the motion of the first celestial body (or a point on it) with respect to a second celestial body. Using the location and motion of the first celestial body, a point in time can be given for a celestial body, which is used to represent the progress of time on the first or the second celestial body.

### BRIEF DESCRIPTION OF THE DRAWINGS

So that the manner in which the above recited features of the present invention can be understood in detail, a more particular description of the Invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1 A, 1 B & 1 C depicts the celestial path of earth, moon and sun.

FIG. 2 depicts the earth clock face.

FIG. 3 depicts the Lunar Month time clock.

FIG. 4 is the time clock.

FIGS. 5A and 5B are Solar System and Barry Center Modeling being represented within the present invention

FIGS. 6 A and 6 B are the non-graphic Milankovitch cycles being represented with the present invention.

FIG. 7 is an example of Interactive calendar interface as per the present invention;

### DETAILED DESCRIPTION

An “orbital track” is the representation of the plan path an orbital body takes about its parent body in relationship only to that body—i.e. the track the Earth takes about the sun or the moon takes about the Earth as referenced from the Earth.

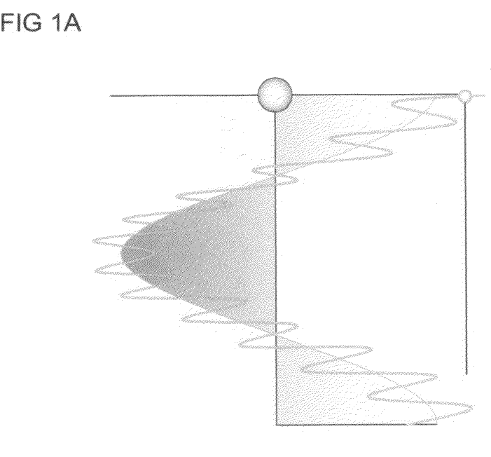

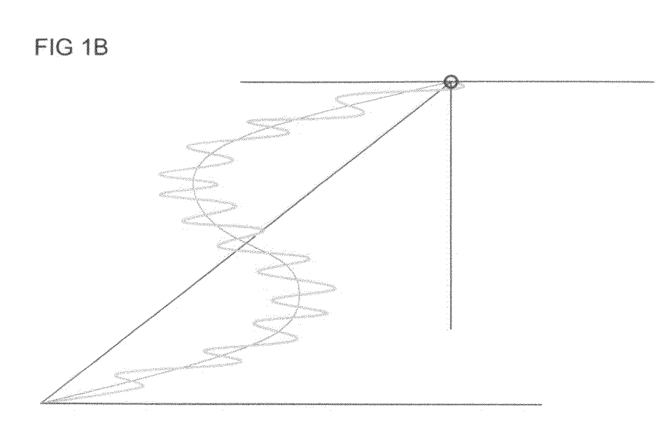

A “celestial path” is the trace bodies would leave if they left contrails as they and the bodies they orbit moved through space along with the body they are orbiting—i.e. the Earth's celestial path would be a spiral as the sun moves forward in its orbit about the Galaxy. How these paths appear depends on the perspective that one takes—if looked at from directly above and in line with the axes of movement, they appear planar (or flat). From the side they appear as a wave. FIGS. 1 A. 1 B & 1 C depicts the celestial path of earth, moon and sun.
Earth's Earth celestial path is the fuzzy blue one
The Moon's celestial path is the fuzzy white one
The Sun's Earth celestial path is the yellow one

### The Earth Clock Face:

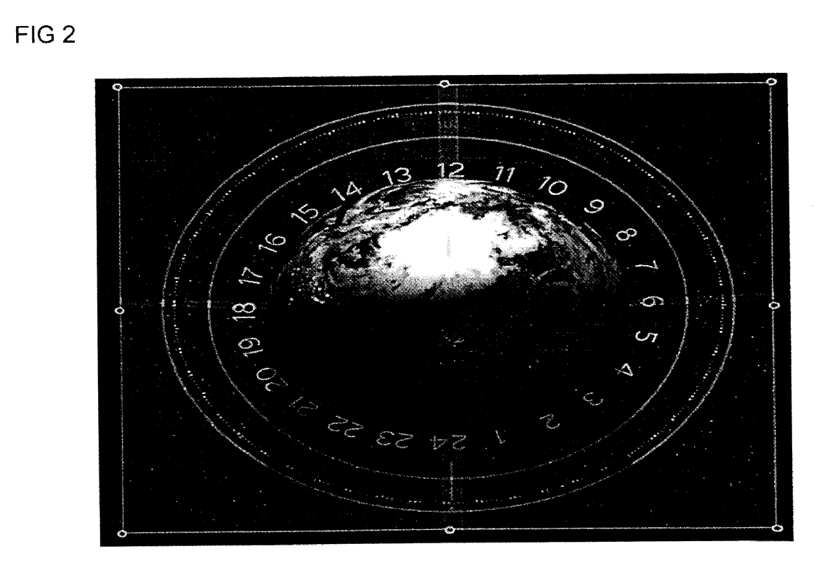

FIG. 2 depicts the earth clock face. We show seconds (and micro second units), minutes, hours and a day by the following means:

#1: A bezel around the Earth (usually but not necessarily the equator) which indicates in any number of ways—(i.e. by numbers, icons, etc) the seconds, micro seconds, minutes, hours for 24 hours.

The time of day for any place on Earth can be chosen to indicate time upon the bezel by any number of graphic depictions including by creating a hand that extends from the chosen place on Earth outward and over the corresponding time on the bezel. Alternatively, a bright dot (or pointer or other indicator) that travels along the bezel and corresponds to the exact time for that place on Earth. Again any number of these can be used simultaneously for various locations in different time zone on Earth For instance we could have one for New Delhi, Tokyo, New York, etc.

Digital time readouts or displays or any places or earth can also be show—as can the whole time zones showing the item for each place on earth by times zone overlays.
We can have a number of digital odometers—
#2: Or we can make some or part or all of the bezel and times Invisible and instead just reveal the times that come up that would have shows that corresponds with chosen location on Earth as it rotates through them. In other words you would not actually see the full bezel—just the time or its number or icon where and when that takes place for the corresponding place on Earth.
#3: The bezel or readouts can additionally or instead of also be laid out along the Earth's celestial path, and thus in 4D space-time
#4: A particular location on Earth could be programmed to leave its own additional trace as it moved through space this path could be notated with a clock bezel or corresponding time notations. This can be in addition to the other paths and bezels or as an alternative method,
#5: Digital time readouts or “odometers” like numeric odometers can also be displayed somewhere on the screen, for example in the upper right hand corner—e.g.: 10:45.001 AM, PDT May 12, 2007 (and/or in other time or calendaring systems can be represented by these numbers/odometers—eg Universal Time, and East Coast US time and or for instance the Jewish, Chinese, Islamic calendar days or other calendaring systems.)
#6: Time can also be read out in audio in ways and means to be selected by the user.

### The Lunar Month:

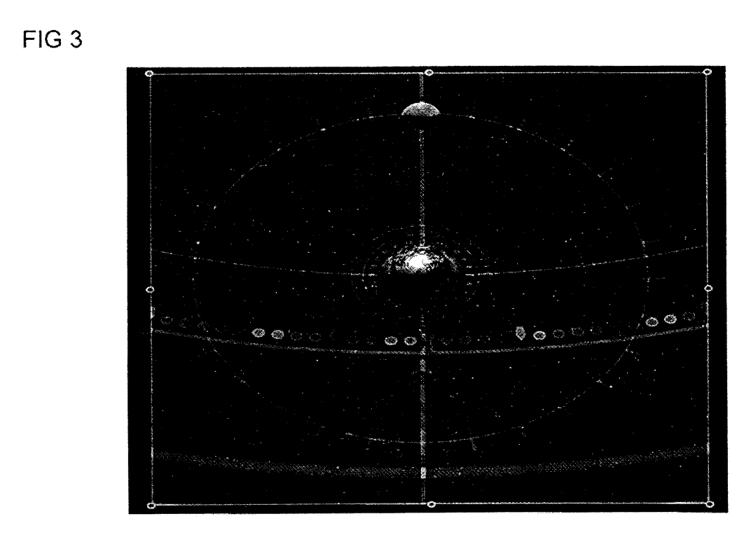

FIG. 3 depicts the Lunar Month time clock.

#1: The lunar month can be seen and marked as a bezel along it Orbital Track.
#2: The markings can be laid out and seen along the Lunar bezel.
#3: Lunar days (or phases as seen from earth) can be revealed as the moon passes each position along its corresponding orbit path respectively
#4: All 28 phases of the moon can be shown along the lunar bezel and/or lunar celestial path and notated or not.
#5: The phases of the moon as seen from Earth can also be shown in alternating images which alternatively flash or rotate between how the moon is illuminated by the sun or how it is seen from Earth.
#6: The phase of the moon as it is seen from the Earth can also be shown in the corner of the screen as correlated in sync animation together with or instead of #2, 3, 4 & 5 above.
This device can also be independently or more likely together form a lunar clock and calendar. It can be used for keeping track of women's menses, fertility and gestation etc. Could also be a PMS calendar too.

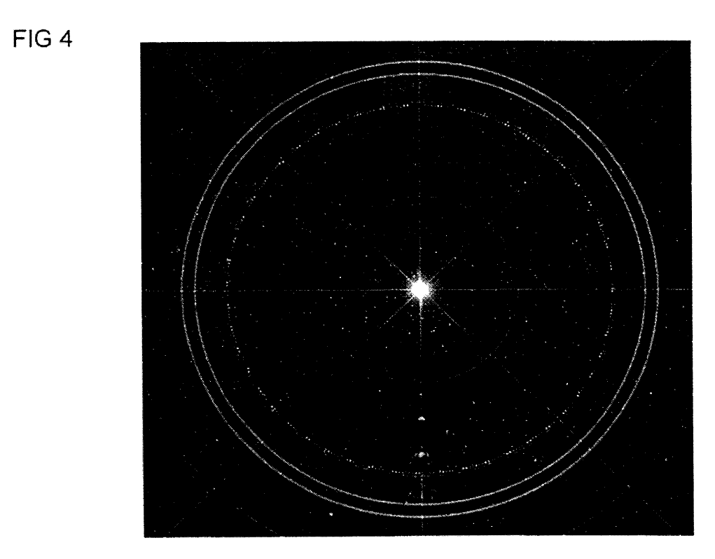

FIG. 4 is the time clock depicting the seconds, minutes, hours, days, weeks, months and the year. The Day Of The Week, The Day Of The Month, The Month & The Year can be told, seen and marked along the Orbit Track and or along the Celestial Path—as part of the day, week, month & year, (above we see only the Orbital Track perspective)

#1: As part of a bezel that in notated in names or relevant symbols etc for the months and with numbers or icons (lets call these graphic notations) that indicate day, week and number.
#2: Alternatively they can appear alone without a bezel—or alternatively rather than showing all of them all at once, we can have these notations reveal themselves one at a time as earth goes along them for each day or month and year. We can do same with all bezels, and numbering and calibrating systems throughout the system/device.
#3: In our example the fifth day is noted with one kind of icon (a diamond shape) and the 10^{th} day with another (an X) and other days a dot. So one can immediately see the first 5 days—understand 6 through the 10^{th} days . . . the 15^{th} day, the 20^{th} day the 25^{th} and 30^{th}, and therefore easily interpolate any date in between. The user, in interactive models, can pick and choose any number of icon, styles and colors for these functions or alternatively just substitute number dates. We can just show numbers, if necessary, or have them appear big—or turn them on or off—etc. The intent is to show where the time is—and can notate it in an infinite number of ways in all calendaring systems—one at a time or in combinations.

Each day of the week can be indicated by color. In our example, weekend days are colored light blue—but the user can pick any color for a day or set of days. Weekdays have their own colors which can also be chosen by the user and can be notated with the numbers or initials of the day and week. This could also be indicated by letter of the day, etc.

Holidays, vacations and other special days can be indicated by background highlighting and colors chosen or special iconic shapes or dynamics such as sparkles, blinking etc and selected individually by the user. These can also pop up on the window or in their own box with notations and previously written reminders . . . and suppose in a computer system we could write algorithms to automatically send notices—order flowers etc.

Special days, e.g. meeting days, or appointments, or birthdays, anniversaries, etc., can be indicated by special icon treatments chosen by the user for such special days. These choices are myriad and can be such things as special colored, shaped or blinking—icons, etc Whatever one wants to graphically indicate can be done.

Because the device of the present invention models the actual movements that make up our days, months and years, we can instantly or simultaneously display and present any time-keeping or calendaring system, whether, Islamic, Chinese, Mayan, ancient, scientific, any other systems and or yet to be invented. The user will be able to choose any particular one or see a combination of any or all—and also see similarities or differences.

The present invention can show a plethora of both historical and up to the moment current world wide terrestrial and Solar information including not but not limited to:
Cloud Cover and weather
Earthquakes
Auroras
Tides
Temperatures
Winds
Solar Wind
Magneto Sphere
Solar wind,
Solar Surface phenomena
Comments

The device of the present invention can be used to show more than seconds, micro seconds, minutes, hours, days, weeks, months and a year. Because the Earth travels through space year after year and moves along with the solar system which also moves through space, the (trace or) paths they (would) leave (if possible) behind them naturally extend seamlessly in an ongoing interwoven spirals from one year to the next adinfenitium. These paths and orbits can be modeled and extended on forward and backward i.e. showing the present time and past time, or projected forward.

Our yearly paths are also part of larger and longer cycles that are themselves imbedded into the much larger cycles and finally fit into the Merry-go-round orbits of our solar system about the Galaxy as it too finds its self part of larger complex patterns. These paths, which we have been on extend backwards some 13 billion years in space-time and can be projected forward in space-time. These cycles are demarked by their own movements and dynamics are revealed and marked in our system similar means as noted earlier in this document.

As we extend our model in scale, In time and in space—other cycles begin to reveal themselves in the patterns—and help proportion the larger time frames which are also celebrate graphically in similar with bezels, numbers, readouts etc. We can mark and notate years graphically into usual patterns of 10's and 100's and 1000's of years and or notate them with Geologic Era's or other temporal measurements, correlations and nomenclature. We can enhance visual understanding with variant color patterns or other graphic devices. Many of these larger cycles come from celestial dynamics which drive and result in terrestrial and evolutionary impacts—our model reveals them an enhances their intuitive understanding (at least in the more animated and robust digital models)

All these and other cycles will be represented within the invention. Some of the more important one's are discussed below:

### Solar System and BarryCenter Modeling:

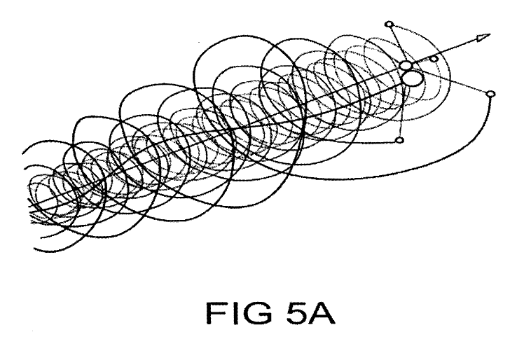

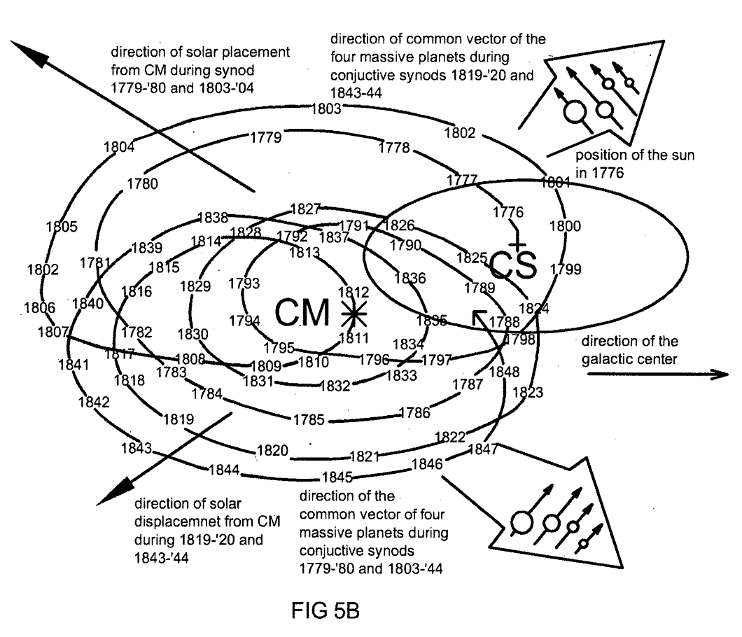

FIGS. 5A and 5B are Solar System and Barry Center Modeling being represented within the present invention. We can also model in more robust models the solar system along with the Barry center. We can tell and show where all solar system elements (including planets, comets, man made satellites and also including non visible forces like the solar wind and magnetosphere, etc) are in relationship to each other and the sun and Earth and their paths and reveal their orbital tracks and paths. Barycenter (i.e. center of mass) of the solar system and the path of the sun about it

### The Milankovitch Cycles

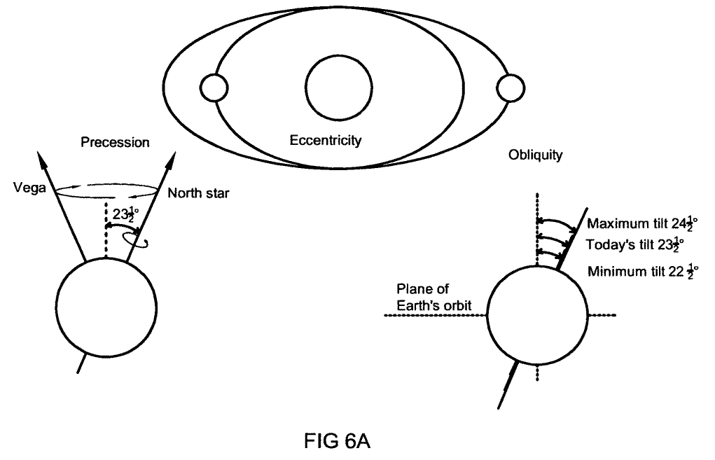

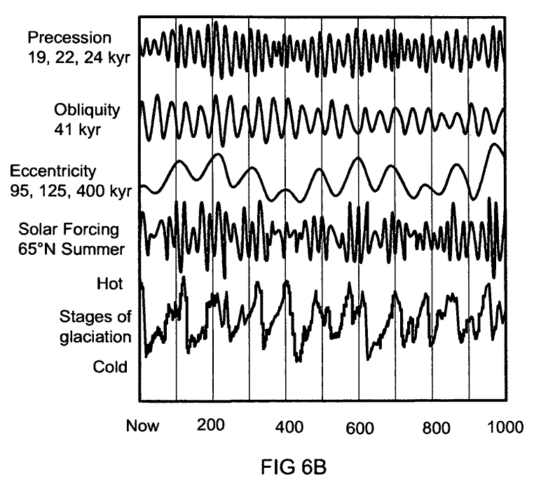

FIGS. 6 A and 6 B are the Milankovitch cycles being represented within the present invention. We will be representing the Milankovitch cycles and they will be a prime component of the graphing of cycles/time frames from 10,000 to 1,000,000 years. Milankovitch cycles are the collective effect of changes in the Earth's movements upon its climate, named after Serbian civil engineer and mathematician Milutin Milanković. The eccentricity, axial tilt, and precession of the Earth's orbit vary in several patterns, resulting in 100,000 year ice age cycles of the Quaternary glaciation over the last few million years. The Earth's axis completes one full cycle of precession approximately every 26,000 years. At the same time, the elliptical orbit rotates, more slowly, leading to a 22,000 year cycle in the equinoxes. In addition, the angle between Earth's rotational axis and the normal to the plane of its orbit changes from 21.5 degrees to 24.5 degrees and back again on a 41,000 year cycle. Presently, this angle is 23.44 degrees.

The Milankovitch theory of climate change or climate forcing is not a perfect system or model—i.e. not entirely accurate when compared with ground truth—mostly but not precisely—in particular, the largest observed response is at the 100,000 year timescale, (approximate) but the forcing is apparently small at this scale, in regards to the ice ages. Various feedbacks (from carbon-dioxide, or from ice sheet dynamics) are invoked to explain this discrepancy.

Milankovitch-like theories were advanced by Joseph Adhemar, James Croll, Milutin Milanković and others, but verification was difficult due to the absence of reliably dated evidence and doubts as to exactly which periods were important. Not until the advent of deep-ocean cores and the seminal paper by Hays, Imbrie and Shackleton “Variations in the Earths orbit: pacemaker of the ice ages” in Science, 1976, did the theory attain its present state.

Our model/device models these cycles and other such cycles and they can be prominently displayed and notated to form part of the empirical visual time line.

### Showing Upwards/Outwards of a Million Years:

### 250 My Orbit of Solar System About Galaxy & Galaxy Through Space

It seems that our Galaxy has made approximately 45 rotations/cycles/spirals as it has spun through space since it's creation only a few billion years after the big bang. As it turns it also moves and displaces its diameter approximately every 300 million years or so.

In our model we leave a celestial paths behind the Galaxy as it turns through space and also behind the solar system as it orbits the galaxy in the same manner as described above [future paths can also be show]. The paths themselves give us a certain understanding of the time frames as every rotation or cycle of the solar system about the Galaxy is roughly 250 million years or 0.25 billion years, or approximately 1 billion years for every 4 rotations. And these can be calibrated in time increments and or other criteria by any means we want. Such increments results in 100 calibrations per rotation of the Earth/Solar System in its orbit around the Galaxy once—but again we can use any divisions we would like to use.

From 10 million years to the present—we can zoom in to see greater detail and acuity. Celestial dynamics such as the milankovitch cycles have their own rhythms—(that we generally don't yet have names for, but which present their own visual pattern which is recognizable and can be remembered as calibrated to years, or multiples of them such as centuries, or 10's of hundred of thousands of years). These paths create a visual pattern that can be recognized as a kind of map or topography of time. Colors, textures and other graphics, etc. can be added to enhance needed understanding and temporal markings. We can zoom in for greater detail—thus holding the proportional view and scales

So all this allows a certain proportionality of understanding of time and time frames. And because it's based on the best understandings of modern science about the movements of the celestial bodies upon which it is based—it's unlikely that it will need to be changed too much over time—though it can and will be updated from time to time to adjust for new understandings and acuity.

The Earth is about 4.6 billion years old so we would see about 18.4 orbital cycles of the Galaxy in that time— . . . and much of the matter that made up the earth has been orbiting the galaxy perhaps over 45 times. Our model will indicate this as part of it's temporal presentation.

The 62My Solar System Merry-Go-Round Ride Around The Galaxy:

It turns out that while the Earth orbits the Galaxy every 250 million years or so we (the Earth & the Solar System) also go up and through the center of the galactic plane—with one full cycle taking about 124 million years. Thus we pass through the galactic plane every 62 million years or so. These dynamics also drive life and evolution on Earth—These are also shown and represented. See an interesting short article about them here: http://news.nationalgeographic.com/news/2005/03/0309_{—}050309_extinctions.html

360 degree interactive viewing creates a potential problem with reading numbers and letters and words that are set up for viewing from one angle, such as the numbers on our clock bezel or the month names on the year bezel. The interactive devices of the present invention will allow numbers and words to be viewed from any angle or direction and read Bright regardless of your viewing. So for instance as you fly around the Earth you will see the earth and the bezel from different angles and our system will always orient the numbers so they always read easily (right side up for the viewer) and they will invert to read correctly when seen from “underneath” This functionality will apply to all names and numbers where reading them “right side up” is essential for the easy use of the device.

NewTime can be expressed in the following devices (and probably some not listed here:
A: Time Keeping Devices:
#1 Mechanical and Analogue Watches and cocks
#2 Digital Watches and Clocks and Calendars
#3 Watches or time keeping devices on cell phones, iPods, PDA's, etc.
#4 Resident in Computers—as a screen saver/clock/calandar/and calendaring system and or interface to their favorite proprietary calendaring system and time line—or can use our own proprietary calendaring interface and system.
#5 Net based Clock/Calendaring system and time lines as stand alone or as integrated parts to more broad ranging systems and presentations
#6 Web based—interactive clock/calandar/time line allowing for the visual correlation of temporal information—and interface for such and analysis of same. In this sense if could be used as a scientific tool or a Google Universe for example. And again as stand alones or as integrated parts to more broad ranging systems and presentations
B: Artistic, narrative and tutorial presentations of time—i.e. books, movies, planetarium presentations and shows that illustrate time.
C: Video Games and other interactive presentations and technology that use time as a major theme or that use our volumetric temporal model in a digital correlated universe as a major component of the Game or technology. Can be presented as a the grounding or basis or the curriculum for Grammar School, High Schools and Colleges. It can be turned into a curriculum—for these things . . . it would have to be annotated with additional material etc. could be delivered on a CD and or put on the web for an interactive curriculum, books or in any of the other media noted in this application.
D: It can even exist as a three dimensional desk object—as a sculpture, as a gizmo—(see video) etc.
E: And finally, as a universal new scientific time line/notation system for marking and correlating all temporal events or items of temporal notation—similar to #6 immediately above—but specifically for or as a scientific time line—or time keeping system for marking tracking or even analyzing temporal events and temporal processes.
#7: Planetarium's, immersive displays such as domes, Virtual Reality, Museum and exhibit and art displays and public displays—television and conversation technologies.

The time keeping devices can also be intend to show evolution and the flow of life-a tree of life animation—a whole representation of evolution and extinctions etc that flows along with the animation of the bodies. It's the third wing—Space. Time. & Evolution. In the time keeping device—especially the animated or interactive ones, the paths through space of the celestial bodies can be shown.

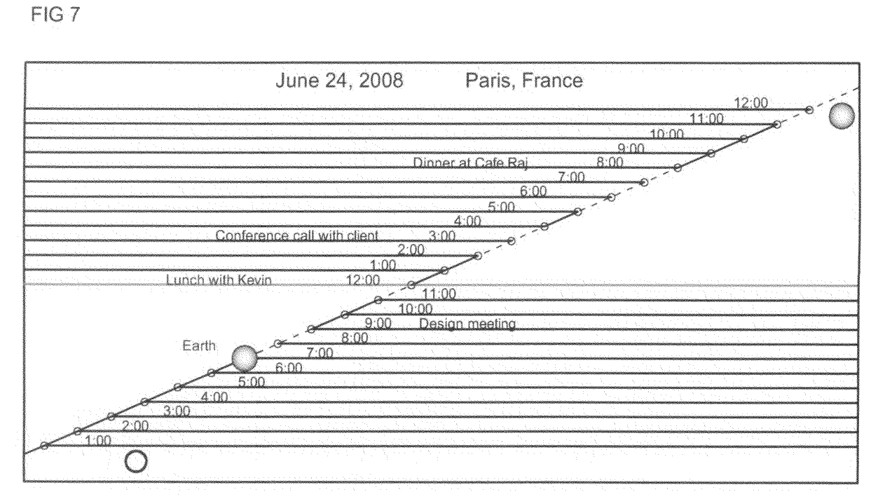

FIG. 7 is an example of a one day page or day representation in the interactive calendar interface. One aspect of the present invention is the orbit of the earth around the sun giving an over view of the year—when seen with—with the Month and 356 day icons bezels, it becomes yearly and monthly calendar. By clicking on one of the day ikons it can zoom into a day calendaring system (or open it) but it reflects a zoom in on a day—and get this page. It allows us to see a day and enter the calendaring information for that day—meetings and the like. The figure represents just one sample day.

The date goes in the top upper right—Before that the phase of the moon as seen from the earth for that day. The diagonal line (from bottom left to top right and in that direction) is the path the earth takes in its orbit of the sun for one day. The little dots in the figure are where the earth would be in that 24 hour period and the dots are the relative size of the earth in a day's transit [about 8 diameters apart from hour to hour—that's how far the earth moves in an hour per its size—distances are exact and not just approximate].

The hour lines line up with where the earth will/would be in that time. AM is represented by lines going to the right. PM lines going to the left—it could be color coded for easier visual understanding and location.

If/when clicked on today's calendar (as opposite dot a future or past date) the location of the earth within the day—is shown by the bigger earth seen on hour 6. The orange dot represents where you are on the earth at that time. The orange curved line is the path you will take on the earth as you pass through space during the day—and at any one of those points in Ume. Past time—on the diagonal line (ie. up to now) is brighter—more defined the blue diagonal. Future time—i.e. time not yet or future from the moment being calendared is more ghostly greyer—it extends and is the diagonal path moving upward—forward from the “now” larger earth.

When you click on an hour or time to calendar—the bigger earth animates up from off screen or where it was before to that time—(Animates means it moves up the line and turns as it goes relative to its turning during the day and duration to that point). Fractions of hours (e.g. 9:15 am or 2:20 PM or multiples of meetings with in one hour are dealt with insets and blow ups.

The little white dot at the bottom left represents the position of the moon in relationship to the bigger (now) earth (same configuration as it is in space at that hour) Again the moon in the upper left corner is the phase of the moon as it would be seen from earth for that time. It constantly changes hour by hour—as you use the calendar—or if you are not “using” it, its the phase for the day.

Hour times and lines are dimmed and only become brighter when there is something calendared on that line—Brighter makes it easier to see. Blocks that extend beyond the hour are blocked off thebright lines and the attached link along the diagonal.

While the foregoing is directed to embodiments of the present invention, other and further embodiments of the invention may be devised without departing from the basic scope thereof, and the scope thereof is determined by the claims that follow.

What is claimed is:

1. A method of time-keeping on a location of a celestial body (first celestial body), comprising:
determining the location of a first celestial body with respect to a second celestial body;
determining the motion of the first celestial body with respect to a second celestial body and other celestial bodies, as it moves along its celestial path in universe;
using the location and motion of the first celestial body to represent a point in time on the first or second celestial body;
using the motion of the first celestial body to represent progression of time on the first or second celestial body, as they move in universe along their celestial paths.

2. The method of claim 1, wherein the first celestial body could be any one of a moon, an asteroid, a planetoid, a planet, a star, a galaxy, a cluster of galaxies and an arbitrary point in the universe.

3. The method of claim 1, wherein the second celestial body could be any one of a moon, an asteroid, planetoid, a planet, a star, a galaxy, a cluster of galaxies and an arbitrary point in the universe.

4. The method of claim 1, wherein said determining comprises: calculating coordinates of said first and second celestial bodies in a celestial coordinate system of a predetermined ephemeral time; and transforming said coordinates to a celestial coordinate system of said desired time.

5. The method of claim 1, wherein said representation includes a digital display.

6. The method of claim 5, wherein the said digital display is on a computer.

7. The method of claim 5, wherein the said digital display is on a wrist watch or pocket watch.

8. The method of claim 5, wherein the said digital display is on a cell phone, PDA, or an iPhone.

9. The method of claim 5, wherein the said digital display is interactive.

10. The method of claim 1, wherein said representation includes a graphical display.

11. The method of claim 10, wherein the said graphical display is on a wrist watch.

12. The method of claim 10, wherein the said graphical display is printed.

13. The method of claim 10, wherein the said graphical display is in a video.

14. The method of claim 10, wherein the said graphical display is in a planetarium, dome or theater of any immersive display of any kind.

15. The method of claim 10, wherein the said graphical display is interactive.

16. The method of claim 1, wherein said representation includes a stereo projection.

17. The method of claim 1, wherein said representation includes an animation.

18. The method of claim 1, wherein said representation includes displaying at least one of (micro) seconds, minutes, hours, days, weeks, months, years, decades, centuries and millennia and beyond (and so forth), extending billions of years back and forward in time.

19. The method of claim 1, wherein said representation includes a 12-hour or 24-hour clock.

20. The method of claim 1, wherein said representation includes displaying information layered over (and or associated with) the said celestial bodies, wherein the displayed information may be any kind of temporal information.

21. The method of claim 20, wherein the said information could be at least one of social and demographic information, [historical, social, economic, financial, cultural, political, spiritual, environmental, climatic, geolotic, human and or evolutionary processes and events] loud cover, geographical features, geophysical, earth quakes, volcanoes, auroras, tides, atmospheric, climatic, temperature, winds, solar winds, magneto sphere, solar spots, galaxial features and user comments.

22. The method of claim 1, wherein said representation includes displaying location and motion of a third celestial body with respect to first or second celestial body.

23. The method of claim 1, wherein said representation includes Milankovitch cycles.

24. A time-keeping device, comprising: representation of a point in time on any of a first and a second celestial body;
representation of progression of time on any of a first and a second celestial body;
by determining the location of a first celestial body with respect to a second celestial body; and,
by determining the motion of the first celestial body with respect to a second celestial body.

25. The device according to claim 24, wherein said device includes a digital display.

26. The device according to claim 24, wherein said device includes a graphical display.

27. The device according to claim 24, wherein the said device is a computer.

28. The device according to claim 24, wherein the said device is a wrist watch.

29. The device according to claim 24, wherein the said device is a phone, PDA, iphone, blackberry, etc.

30. The device according to claim 24, wherein the said device is interactive.

31. The device according to claim 24, wherein the said device is a stereo projector, or stereo viewing system or stereo volumetric display.

32. The device according to claim 24, wherein said the said device is a calendar displaying at least one of seconds, minutes, hours, days, weeks, months, years, decades, centuries and millennia and billions of years etc.

33. The device according to claim 24, wherein the said device is used to present time in any calendaring system or multiples of various calendaring systems simultaneously and to co-correlate and also translate between them.

34. The device according to claim 24, wherein the said device displays information layered over the said celestial bodies.

35. The device according to claim 34, wherein the said information could be at least one of special, atmospheric, climatic, environmental, geographic, geophysical, teresterial, oceanographic, hydrospheric bathometric, biospheric, cryspheric, loud cover, geographical features, earth quakes, volcanoes, auroras, tides, temperature, winds, solar winds, magneto sphere, solar spots, galaxy features and user comments.
